(19) United States
(12) Patent Application Publication
(10) Pub. No.: US 2004/0083866 A1
(43) Pub. Date: May 6, 2004

(54) Method and apparatus for saw cutting tubes

(76) Inventor: John J. Borzym, Northville, MI (US)

Correspondence Address: THOMAS N. YOUNG, Young & Basile, P.C., Suite 624, 3001 West Big Beaver Road, Troy, MI, 48084, US

(21) Appl. No.: 10/287,940

(22) Filed: Nov. 4, 2002

(51) Int. Cl. B26D 3/00; B26D 1/18

(52) U.S. Cl. 83/54; 83/178; 83/483; 83/646; 83/663

(57) ABSTRACT

A method of saw cutting relatively thin walled metal tubing in a relatively burr free fashion by causing the cutter blade to move through a path of travel which maintains an essentially tangential relative motion vector between the saw teeth and the tube wall at the place of engagement during some or all of the movement of the blade center around the tube center. Both ring blade and disc-type saws are disclosed and a two axis displacement system using digitally controlled ball screw actuators is provided.

### FIELD OF THE INVENTION

This invention relates to methods for producing essentially burr free saw cuts of tubing made of steel and other metals as well as to an apparatus for carrying out the methods.

### BACKGROUND OF THE INVENTION

Metal tubing is used in the fabrication of numerous products including automotive components, furniture, bicycle frames and other structures. The tubing itself is manufactured in various ways, one common process involving the steps of roll forming flat strip stock into the desired shape, usually but not necessarily a circle, welding the seam where the edges of the stock are brought together and cutting the tubing to manageable lengths. The lengths of tubing are then bundled and shipped to a fabricator who recuts them according to the length needed to create specific products.

In both the recut operation and the original cutting at the tube mill, it is highly desirable to produce an undeformed tube end so as to eliminate the need for secondary reshaping operations. The best end shapes can typically be produced with rotating saws rather than penetrating guillotine blades which tend to dent the tube when the blade enters it. However, prior art saws are generally used in such a way as to produce metal burrs which create handling dangers and must in any event be removed before using the tube to fabricate a finished product.

It is my discovery that the presence of burrs on otherwise good quality saw cuts is a result of sawing in such a way that the direction of the motion of the saw blade in the area of engagement with the tube is at too great an angle with the tube wall; i.e., while the saw blade enters the tube wall with tangential relative blade travel, the direction of motion of the teeth relative to the tube wall during later stages may be at or nearly at right angles to the tube wall.

An interesting apparatus for saw cutting tubular work pieces is disclosed in U.S. Pat. No. 4,471,678 issued Sep. 18, 1984 to Jean Claude Davis of Lyon, France. This patent discloses an internally toothed ring blade saw mounted for rotation on a carriage subject to biaxial orbital movement by means of a hydraulically powered crank. The diameter of the saw blade is much larger than the diameter of the tube and the direction of blade motion relative to the tube wall is at an angle of about 50° or more over a substantial portion of the cutting process. As a result, it is my belief that this saw will exhibit the tendency discussed above to produce burrs on the cut ends. In addition, since a single crank is used, independent control of the X and Y axis movement of the blade relative to the tube appears to be impossible. Moreover, the stroke length (diameter of the circle defined by the movement of the blade center) is fixed for a given crank arm. Orbital and other non-round paths of blade-center travel are impossible.

### SUMMARY OF THE INVENTION

My primary objective is to improve on prior art saw cutting of tubular workpieces by substantially reducing the tendency of the saw blade to produce burrs. In general I achieve this by bringing a rotating blade into engagement with the wall of the tube to be cut such that the direction of blade motion relative to the wall at the place of engagement is essentially tangential rather than nearly or essentially radial and thereafter moving the blade along a path which maintains the tangential engagement while advancing the place of engagement around the tube wall to the desired degree. For a round tube shape, I am able to maintain the desired blade motion relationship all the way around the tube. For non-round shapes, I am typically able to maintain desired relationship over much of the cutting path, thereby achieving a proportional improvement over the prior art.

In one embodiment of my invention, the blade is a ring blade with internal teeth. The blade diameter is preferably no more that about 110% of the tube diameter when round tube is being cut. This not only helps to assure that the direction of the blade motion at the place of engagement is nearly or essentially tangential, but also dramatically reduces the amount of blade translation which is required to produce the desired depth of cut.

In another embodiment, the blade is a disc-type of blade with external teeth and the blade is inserted into the center of the tube. While this method is typically used only for cutting short lengths of the tube in a recutting operation, I have found it works to advantage in these applications for the reasons described above. Preferably, the blade diameter is no less than about 90% of the tube diameter.

Another objective is to provide an apparatus for saw cutting tubes by providing means for mounting and rotating a rotatable saw blade while providing simultaneous but independently variable X and Y axis movement of the center of the saw blade relative to the tube center so that the path of travel of the saw blade center can be any desired shape including circular and oval. This is achieved by means of actuators such as ball screws which are independently controllable.

Still another objective is to provide a ring blade which also acts as a chamfering tool to provide chamfered tube ends on both sides of the cut.

These and other advantages of the present invention will be best understood from a reading of the following specification which describes illustrative embodiments of my invention. The specification is to be taken with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a plan view of a ring blade apparatus for saw cutting tubing and constructed in accordance with the invention;

FIG 1A shows the path of travel of the blade center in the apparatus of FIG. 1;

FIG. 2 is a side view in cross section of a portion of the apparatus of FIG. 1 illustrating how a chamfer cut is made;

FIG. 3 is a side view partly in cross section of a second embodiment invention using a disc blade mounted on a spindle and contacting the work piece from the interior thereof;

FIG. 4 is a plan view of a portion of the apparatus of FIG. 3 showing the direction of the blade rotation and indicating the path of travel;

FIG. 4A is a larger view indicating the path of travel followed by the blade center in performing a cut in accordance with my invention, and

FIG. 5 is a plan view of a portion of the apparatus of FIG. 1 making a cut through a length of tubing having an oval cross section.

### DETAILED DESCRIPTION OF THE ILLUSTRATIVE EMBODIMENTS

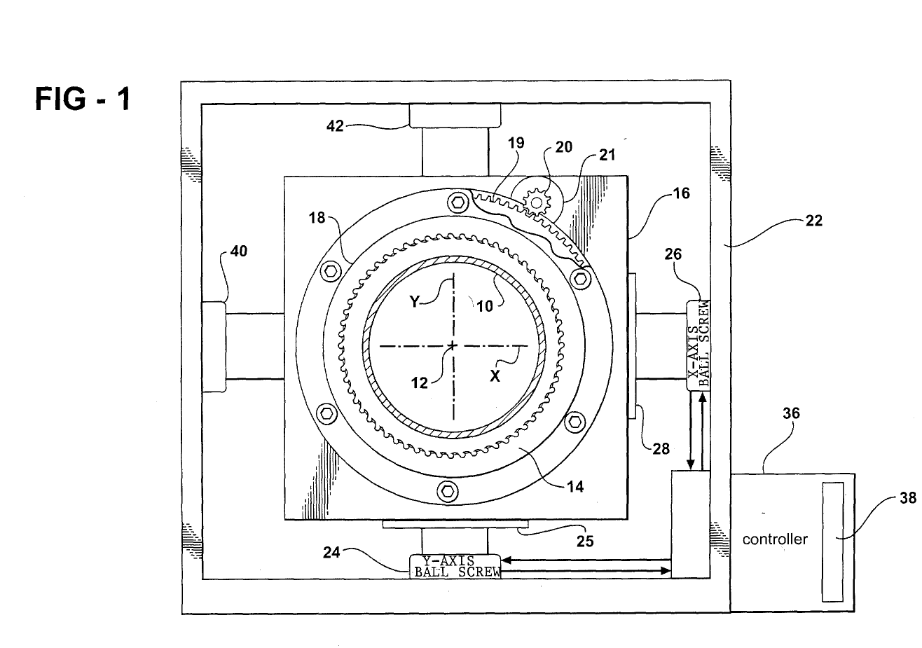

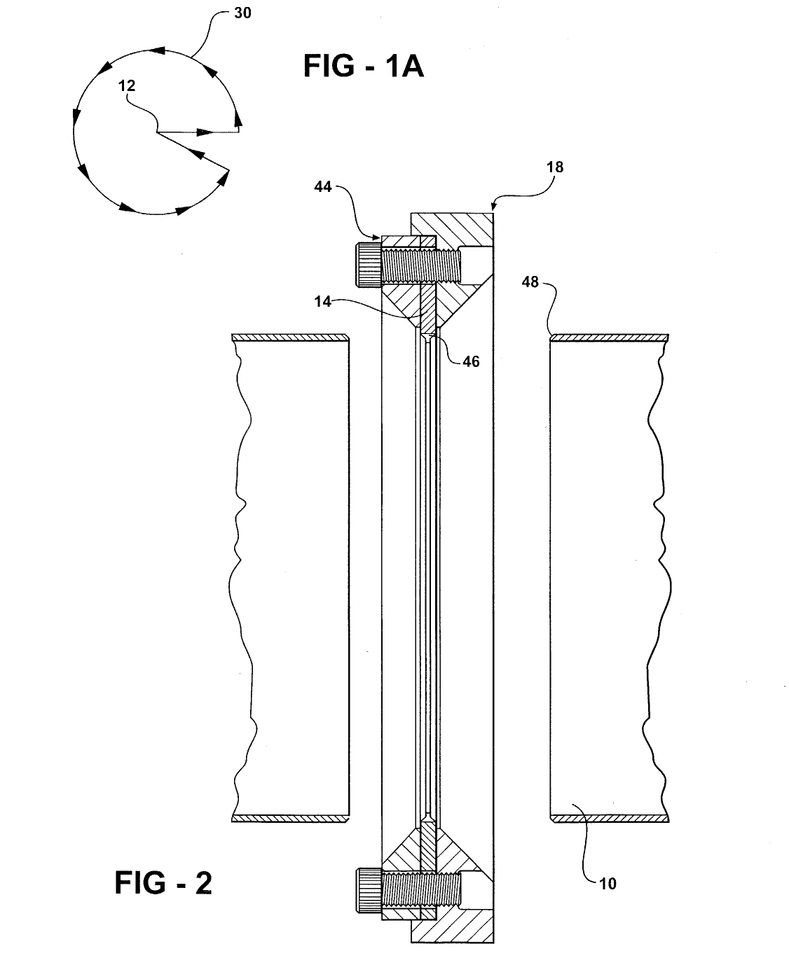

Referring to FIGS. 1, 1A and 2, a steel tube 10 having a circular cross section and a center of geometry 12 located at the intersection of orthogonal X and Y coordinates is shown centered within a ring-type saw blade 14 mounted in a frame 16 by means of a holder 18 which is bolted to the frame for convenient attachment and release. The cutter holder 18 is provided with a retainer 44 and bearings (not shown) to permit rotation of the blade 14 relative to the frame 16 in either direction. The holder is further provided with a peripheral bull gear 19 engaged by pinion 20 of motor 21 to rotate the cutter holder 18 at the desired speed; e.g., about 300 surface feet per minute. This figure is given by way of example only and correlates with a rotational speed of about 650 RPM. Although no dimensions are shown in FIG. 1 and my invention is applicable to nearly any size tube, a typical application involves the saw cutting of welded steel tube with a diameter of between 1 and 6 inches. The diameter of the ring-type saw blade 14 is preferably no more than about 110% of the outside diameter of the tube 10. Therefore the inside diameter of the saw blade 14 would be 5.5″ to cut a length of tube having an outside diameter of 5″. The blade 14 is made of hardened and/or alloyed steel and has between about 30 and 130 teeth the depth of which is close to or just greater than the thickness of the tube wall.

The frame 16 is mounted within an outer base frame 22 constructed of ridged steel or other suitable material; e.g., aluminum. Means are provided to programmably repeatedly displace the inside frame 16 and the cutter blade 14 relative to the geometric center 12 along the X and Y coordinate axes independently of one another. In the embodiment shown in FIG. 1 this means comprises a first ball screw assembly 24 mounted on the inside bottom surface of the exterior frame 22 and having an actuator engaging a slide 25 attached to the bottom outside surface of the interior frame 16 to provide displacement of frame 16 along the Y axis. A second ball screw actuator assembly 26 is mounted to the inside of the outer frame 22 and operatively disposed in part in a slide 28 mounted on the outside right vertical surface of the inner frame 16 to provide controlled displacement of the frame along the X axis. Both ball screw actuators are connected to receive position commands from a microprocessor controller 36 during a saw cutting operation. Each ball screw actuator is provided with a linear displacement transducer to provide instantaneous position information back to the controller so that, using conventional servo loop technology, the controller can compare the actual position of frame 16 to a commanded position along each of the X and Y axes and produce a difference signal which is used to reduce the sensed position error to zero. In this fashion, the center of the frame 16 can be made to follow a path such as the circular path 30 shown in FIG. 1A or an oval-shaped path as desired.

Stepper motors can be substituted for the ball screw actuators and can be driven either directly or as part of a servo loop.

The controller 36 is provided with means 38 such as a tape or disc reader to produce independent translations of the frame 16 along the X and Y axes during rotation of the saw blade 14 to bring the teeth of the saw blade into essentially tangential engagement with the tube wall to produce a saw cut of the desired depth in a relatively burr free fashion.

The path 30 shown in FIG. 1A assumes a full depth cut in one pass and, therefore, is less than a full 360° circle. Where multiple passes are programmed to produce a final depth needed to sever the tube 10, one or more 360° translations may be required before returning the geometric center of the frame 16 and blade 14 to the geometric center 12 of the tube 10.

The direction of the displacement of the geometric center of the frame 16 is shown opposite to the direction of rotation of the blade 14. While desirable, this is not always necessary; i.e., the two displacement paths may be in the same direction and/or may be the reverse of that shown. It will be noted in FIG. 1 that the teeth of the saw blade 14 are configured asymmetrically to indicate a preferred direction of cut according to the directional arrow at the top right but it has been found that clean cuts can be made by rotating the saw in the opposite direction; i.e., against the forwardly canted peak of the saw teeth.

Sliding supports 40 and 42 are provided between the outside of the inner frame 16 and the inside of the outer frame 22 to accommodate the displacement of the frame 16 produced by the ball screw actuators 24 and 26.

As shown in FIG. 2 the blade 14 is mounted in a retainer 44 for attachment to the power holder 18. Other structural arrangements can of course be used.

As also shown in FIG. 2 the interior edges of the blade 14 are chamfered at 46 to produce a chamfer 48 on both ends of the tube 10 as a result of a through cut.

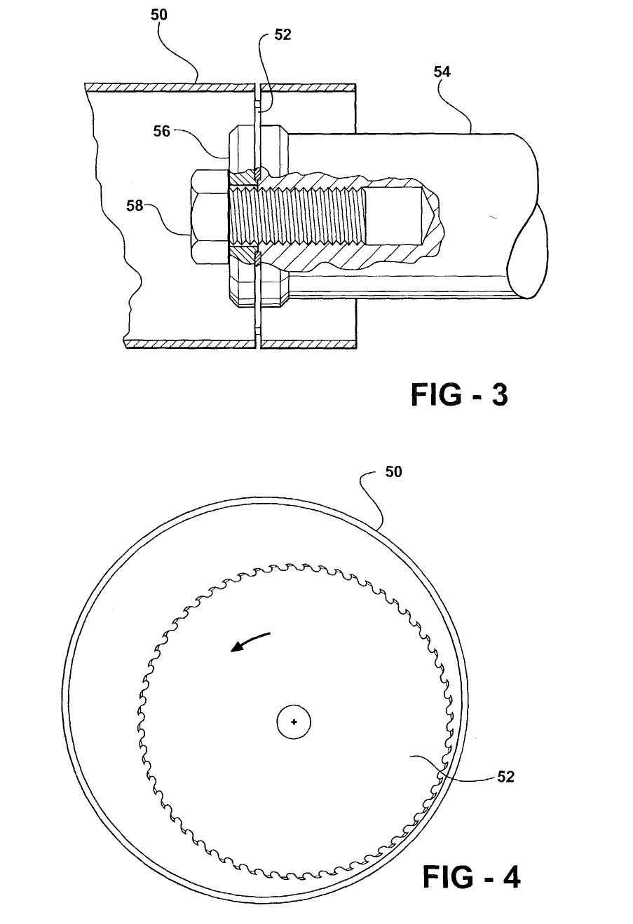

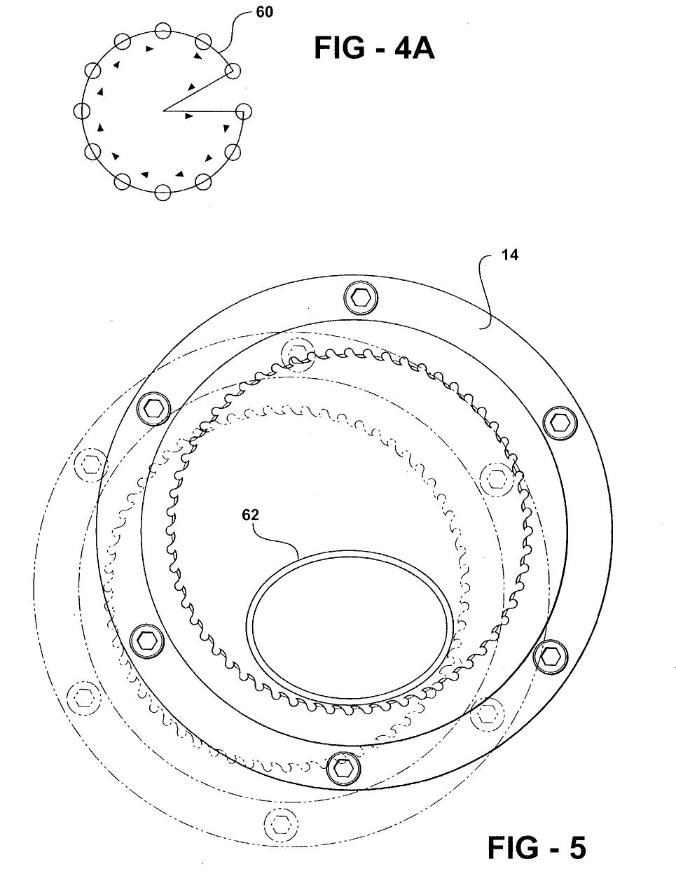

Looking now to FIG. 3, a second embodiment of the invention used for cutting circular tube 50 includes a disk-type blade 52 having external teeth adapted for rotation in the direction shown in FIG. 4. The blade 52 is mounted on a spindle 54 by means of a retainer structure having an axial bolt 58. The spindle is inserted into and through the open end of the tube 50 and is therefore limited to recut operations involving relatively short lengths. The limiting factor is the ability to support the cantilevered spindle 54 so that it does not bend or deflect during a cutting operation.

It will be understood that the spindle 54 is mounted on a two axis displacement control system generally of the type shown in FIG. 1 wherein electronic digitally controlled ball screw actuators, stepper motors or the like are used to provide simultaneous but independent displacement along each of two orthogonal axes. The peripheral speed of rotation of the blade 52 is again approximately 300 surface feet per minute and the diameter of the blade 52 is preferably not less than about 90° of the inside diameter of the tube 50. This ensures an essentially tangential motion factor for the teeth of the blade at the place of engagement with the inside wall of the tube 50 during most or all of the cutting operation. The path of travel 60 of the geometric center of the spindle 54 is shown in FIG. 4A. As before the center of rotation of the cutter moves radially outward from a point of coincidence with the geometric center of the tube 50 until the blade 52 has fully penetrated the wall of the tube 50 at which time the center of rotation of the blade is moved through a circular path 60 of approximately 340° and returned to the geometric center of the tube.

Because the X and Y axis displacements of the cutter blades 14 and 52 can be independently controlled during the cut, shapes other than circles may readily be cut while preserving the tangential motion vector over much of the cut. FIG. 5 shows such an arrangement wherein the blade 14 is used to cut through a tube 62 having an oval-shape. In this instance the inside diameter of the blade 14 is greater than the maximum diameter of the tube 62.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method of saw cutting the wall of a tube with a rotating saw blade comprising the steps of:
a. bringing the rotating blade into engagement with the wall such that the direction of blade motion relative to the wall at the place of engagement is substantially tangential; and
b. moving the blade along an arcuate path which maintains a substantially tangential engagement while advancing the place of engagement around the tube wall.

2. The method defined in claim 1 wherein the saw blade is a closed ring having internal teeth which surround the tube.

3. The method of claim 2 wherein the blade is symmetrically chamfered.

4. The method defined in claim 2 wherein the arcuate path is at least substantially a circle.

5. The method of claim 2 wherein the diameter of the ring blade is no more than about 110% of the tube diameter.

6. The method of claim 1 wherein the rotating blade is a disc having external teeth and is disposed inside of the tube.

7. The method of claim 6 wherein the path is essentially orbital.

8. The method of claim 6 wherein the diameter of the blade is no less than about 90% than the inside diameter of the tube.

9. Apparatus for saw cutting a tube comprising:
a saw blade;
means for mounting a saw blade for rotation about an axis of rotation; and
means for effecting independently controllable X and Y axis movement of the center of rotation relative to the center of the tube wherein X and Y are orthogonal axes at essentially right angles to the longitudinal axis of the tube.

10. Apparatus as defined in claim 9 wherein the blade is ring-shaped with internal teeth.

11. Apparatus as defined in claim 9 wherein the diameter of the ring blade is no more than about 110% of the diameter of the tube.

12. Apparatus as defined in claim 10 wherein the saw is symmetrically chamfered.

13. Apparatus as defined in claim 9 wherein the blade is a disc with external peripheral teeth.

14. Apparatus as defined in claim 13 wherein the diameter of the disc blade is no less than 90% of the inside diameter of the tube.
